(19) United States
(12) Patent Application Publication
(10) Pub. No.: US 2019/0114592 A1
(43) Pub. Date: Apr. 18, 2019

(54) APPARATUS, SYSTEM, AND METHOD FOR SIMULTANEOUS APPLICATION AND ASSIMILATION OF A PLURALITY OF PERSONS

(71) Applicants: Jeremy MacDonough, Tolland, CT (US); Benn Dubois, Manchester, CT (US)

(72) Inventors: Jeremy MacDonough, Tolland, CT (US); Benn Dubois, Manchester, CT (US)

(21) Appl. No.: 16/158,142

(22) Filed: Oct. 11, 2018

Related U.S. Application Data
(60) Provisional application No. 62/571,794, filed on Oct. 13, 2017.

(51) Int. Cl. G06Q 10/10; G06Q 30/02; H04L 29/08

(52) U.S. Cl. CPC G06Q 10/1053; H04L 67/306; G06Q 30/0277

(57) ABSTRACT

Disclosed herein is a method for application of and assimilation of a plurality of persons to an offer, the method comprising: providing, via a webpage, an advertisement board comprising a plurality of offers, the advertisement board being in communication with a storage database and capable of displaying two or more offers, the offers posted by an enterprise, organization, institution or alike institute; retrieving, via the computer, the application form for a posted offer from a storage database, the offer corresponding to a practice, employment, studentship or alike opening; providing, via a webpage, the application form for a selected posted offer, wherein the application form is populated by a plurality of persons; and submitting, via the computer, the completed application form for a posted offer to a storage database; wherein a plurality of persons applying to the posted offer are represented in a single form. A corresponding apparatus, system and computer program product also are disclosed.

### CROSS-REFERENCE TO RELATED APPLICATIONS

This U.S. patent application claims the benefit of U.S. Provisional Patent Application No. 62/571,794 filed on Oct. 13, 2017, which is incorporated herein by reference.

### BACKGROUND

The disclosed embodiments pertain to application and personnel processing using a computerized system.

Various techniques of job, career, and educational institution admittance management services, in addition to other types of admittance processes requiring an application to be completed, submitted for filing, and reviewed for decision in regards to the applicants and their respective credentials have been tried. This process can be, and is commonly, handled by, but is not limited to, a human resources management department, or third party representative. Most commonly this process takes the form of physical application (ie. paper form), or some electronic equivalent (ie. computing device with an electronic fillable form and electronic filing technique).

Resume creation and processing via an online system, including an online form or digital file retrieval, completion, filing, and analysis under various techniques, are known to the art, and are used in a variety of fields. A resume in the form of a digital, transmittable file is most commonly associated with an application process, whereas an applicant can submit their resume file to an online application system for retrieval and examination by an intended receiver. However, limitations exist in connection with the commercially used online application processing systems.

It would be useful to develop improvements to online application processing that overcome the shortcomings of currently known systems.

### SUMMARY

One embodiment described herein is a method for application of and assimilation of a plurality of persons to an offer of occupation. The method comprises: providing, via a webpage, an advertisement board comprising a plurality of offers, the advertisement board being in communication with a storage database and capable of displaying two or more offers, the offers posted by an enterprise, organization, institution or alike institute; retrieving, via the computer, the application form for a posted offer from a storage database, the offer corresponding to a practice, employment, studentship or alike opening; providing, via a webpage, the application form for a selected posted offer, wherein the application form is populated by a plurality of persons. The method also comprises submitting, via the computer, the completed application form for a posted offer to a storage database, wherein a plurality of persons applying to the posted offer are represented in a single form.

Another embodiment is an apparatus comprising: an advertisement board module in communication with a storage database that provides, via a webpage, an advertisement board comprising a plurality of offers, the advertisement board module capable of displaying two or more offers; an application module in communication with a storage database that:
retrieves, via the computer, the application form for a posted offer from the storage database, the offer corresponding to a practice, employment, studentship or alike opening;
provides, via a webpage, the application form for a selected posted offer; wherein the application form is populated by a plurality of persons; and submits, via the computer, the completed application form for a posted offer to the storage database;
retrieves, via the computer, the completed application form for a posted offer from a storage database;
provides, via a webpage, a view of the retrieved completed application form; and
transmits, via a computer, a proposal of terms for assimilation of the plurality of persons into the enterprise, organization, institution or alike institute; and

a user profile module that:
manages one or more users having accounts;
wherein the user accounts can be created, modified or removed; and connects user profiles during application of and assimilation of a plurality of user profiles to an offer.

A further embodiment is a computer program product comprising a non-transitory computer readable storage medium storing computer readable program code, the program code, when executed by a processor, cause the processor to perform: providing, via a webpage, an advertisement board comprising a plurality of offers, the advertisement board being in communication with a storage database and capable of displaying two or more offers, the offers posted by an enterprise, organization, institution or alike institute; retrieving, via the computer, the application form for a posted offer from a storage database, the offer corresponding to a practice, employment, studentship or alike opening; providing, via a webpage, the application form for a selected posted offer; wherein the application form is populated by a plurality of persons; and submitting, via the computer, the completed application form for a posted offer to a storage database; wherein a plurality of persons applying to the posted offer are represented in a single form.

A further embodiment disclosed herein is a method for simultaneous application of and assimilation of a plurality of persons into offer presented by an enterprise, organization, institution, or alike entity to fulfill a practice, employment, studentship, or alike offer comprised of: an advertisement of offer; retrieval of an application form; completion of said form; and submission of said form to an internet accessible storage device; whereas all applying persons are represented with a single such form; review and determination for the candidacy of the applicants for the advertised offer(s) is made via the contents of said application form; and the simultaneous assimilation of accepted applicants into said enterprise, organization, or institution.

Yet another embodiments is a method of filing and assimilating a plurality of applicants on a single application comprised of: the creation of an advertisement of an offer by an offered; a specified, or choice of, applicant assimilation format as a type:
a. Applicants apply into and for a singular or identical specified offer(s), in which all applicants, upon acceptance and assimilation into the stated offer(s), would functionally be placed under an identical title(s), program(s), situation(s), or responsibility(s) at simultaneous operating times and at an identical or different operating location(s);
b. Applicants apply into and for a singular or identical specified offer(s), in which all applicants, upon acceptance and assimilation into the stated offer(s), would functionally be placed under an identical title(s), program(s), situation(s), or responsibility(s) at different operating times and at an identical or different operating location(s);
c. Applicants apply into and for different specified offers, in which all applicants, upon acceptance and assimilation into the stated offers, would functionally be placed under different titles, programs, situations, or responsibilities, be it at a simultaneous or different operating time(s) and/or location(s);
d. Or some combination of the preceding options, whereas a subgroup(s) of the applicants select one of the preceding options that differs from the option choice of another subgroup(s) of applicants;
e. the applicants' retrieval of, or access to, a corresponding application form; completion of said form; submission of said form to a database; retrieval and review of submitted application form by offeror; determination made on said application; and appropriate execution of assimilation format on successfully approved applicants.

Yet another embodiment is an apparatus comprised of: a computing device connected to a memory, of which offers, uncompleted application forms and completed application forms are stored, accessed, and submitted; where user computers may send requests to access offer information, as well as access or download a corresponding application form, as well as submit or upload completed applications; offerors can create or edit offers, as well as view completed applications. In embodiments, the apparatus further comprises a social network system, such that applicants store their information within a user profile saved on a memory storage system; users can connect to each other; users can request to complete an application with other users; and profile information can be transferred to an application form field.

A further embodiment is a computer program for processing the submission of applications containing a plurality of applicants comprised of: a module to manage and organize any and all data storage or information transfer; a module to create and port an offer; a button or link to redirected interested applicants to an application form; a module for creation user profiles, connecting between user profiles, and simultaneously completing an application among a plurality of users; a module to submit an application, a module to access, organize, review submitted applications; a module allowing an offeror to communicate with any group of applicants associated with an application for a particular offer; and a module to query a listing of stored offer with various filters.

Another embodiment is a computer program product comprising a non-transitory computer readable storage medium storing computer readable program code, the program code, when executed by a processor, causing the processor to perform: providing, using a first computer, an opportunity for joint applications to be processed; receiving, using the first computer or a second computer, information for a posting from an entity, the posting corresponding to at least one of a job and admission to an academic institution; providing, using at least one of the first computer and the second computer, an application to be jointly completed by two individual applicants using at least a third computer; submitting, using at least the third computer, a joint application.

### BRIEF DESCRIPTION OF THE DRAWINGS

FIG. 1 shows a flowchart of a method according to an embodiment described herein.

FIG. 2 shows a flowchart of the subprocess of the application form completion step noted in 1-4.

FIG. 3 shows a block diagram of one version of an application form, including its sections.

FIG. 4 shows a block diagram of the offering(s) advertisement in reference to step noted in 1-1.

FIG. 5 shows an example of a version of an application form that can be completed electronically and saved as a document.

FIG. 6 shows an example of an advertisement for a job offer with a choice of assimilation format.

FIG. 7 shows a system according to a first embodiment described herein.

FIG. 8 shows the interrelationship among the modules and computer included in one embodiment described herein.

FIG. 9 shows the interrelationship among the modules and computers included in another embodiment described herein.

FIG. 10 shows the hardware used in practicing certain embodiments.

FIG. 11 is a used profile webpage block diagram in accordance with embodiments disclosed herein.

FIG. 12 is an entity profile webpage block diagram in accordance with embodiments disclosed herein.

FIG. 13 is an administrator profile webpage block diagram in accordance with certain embodiments.

FIG. 14 is a job post module webpage block diagram in accordance with embodiments disclosed herein.

FIG. 15 is a job application module webpage block diagram in accordance with embodiments disclosed herein.

FIG. 16 is a payment processing module block diagram in accordance with embodiments disclosed herein.

### DETAILED DESCRIPTION

One embodiment described herein is a method comprising issuing an initial advertisement of offer(s), issuing an application form, filing of said form, a review of and decision made on said form and its contained applicants, and a technique of assimilation for accepted applicants into the said offer(s). This method allows a plurality of persons to file simultaneously an application to fulfill an offer presented by a host enterprise, organization, or institution. All applicants are represented within the single application form as both individuals and as a collective group with its own unique information, skills, and traits. This allows for a better representation of the individuals as a collective unit in their productivity or qualification for the application's purpose, which in turn, may present this collectivite as a more desirable choice to the said host of the offer(s) than receiving individual applications for each of the same persons involved.

Separately applying to an offer or plurality of offers by traditional means requires the viewing of each applicant's skills, traits, experiences, and information separately and does not include a method to view the skills, traits, experiences, and information of the group of applicants. In addition, a technique of assimilation for any accepted group of applicants is an innovation to traditional application processing methods of the art. This allows for a maximization of productivity and/or effectiveness when integrating accepted groups into their offer(s). This system and method also minimizes the amount of resources, such as paper consumption, data storage, and processing time, needed to process an equal number of applicants by combining them onto one single application form.

One embodiment disclosed herein is an apparatus and method to the practice of application and applicant processing in connection to an offer(s) involving an integration of accepted applicants into a program, title, or position requiring their presence and/or effort, of which is comprised of employment opportunity(s), or educational institution admittance(s), governmental position, volunteer service, military service, or sports team admittance. It allows for a plurality of applicants to apply and assimilate simultaneously into, but is not limited to, a desired enterprise, business, non-profit organization, governmental organization, educational institution, sports team, or event for an advertised offer(s). In embodiments, a single application form is comprised of an informative representation for each of the plurality of applicants, as well as including a representation(s) of some grouping(s) of said plurality of applicants. This group representation is comprised of their shared skills, accomplishments, experiences, or information. Accepted applicants are assimilated into the said offer by a method described below in an advantageous embodiment.

In embodiments, the process uses an applicant assimilation format (defined within), alongside the use of a plurality of applicants represented within a single application form filing. The process and system can be implemented in the fields of business and education. The process and system can be used in connection with original forms, and can be used to modify pre-existing application forms. The process and system can include an informational representation on each of the plurality of applicants individually as well as a representation(s) of the plurality of applicants as a group or group(s) via discrete sections. In embodiments, this process and system enable a particular group of applicants to apply via the disclosed process, instead of the same individuals applying separately. In embodiments, only their sum total of experiences are shown, as they may feel their productivity, represented potential, or desirability is improved by their representation as a group, rather than only as separate individuals; therefore potentially having an effect on the application's final verdict or decision.

Improvements to the resource consumption required for the processing of an equivalent number of applicants if done through individual means can also be improved by the use of this process. Business or educational situations where a plurality of openings exist, or the specific need for a cohesive group of people to fulfill a task can also be greatly improved via this process.

### Definitions

As used herein, “offer” or “offering”, and their plurality, refers to a variety of potential situations in which there is an offer, an offeror, and a notice or advertisement of said offer. This offer is of the type where it involves the applying persons seeking assimilation with the entity of the offeror. The potential practical situations comprise, but are not limited to, a job opening, apprenticeship, internship, interview, or trial opportunity to fulfill a job opening, organization membership, governmental position, educational institution admittance, military service, volunteer service, private group admittance, sports team membership or admittance, private gathering admittance, social or commercial event admittance, personnel opening, vacancy, or other offering requiring acceptance, admittance, or approval via application form filing, review, and determination.

The terminology, herein, of “advertisement”, and its plurality, refers to any audio, visual, or textual presentation of said offer as an online post. The potential practical implementations are comprised of, but not limited to, electronic audio recording, text, graphic, image, video, interactive media, or any combination of such via online post.

As used herein, the term “occupation” refers to status as an employee and to status as a student. A person can have an occupation as an employee and/or student.

The terminology, herein, of “application form” refers to a fillable form of which its applicants, or legal third party representative, may input and complete with information representative of the applicant(s). This informative representation is comprised of the skills, traits, experiences, references, and other beneficial information of the applicants for the success of their application. This form may be presented as a single fillable document, or file, or as a web page, or collection of web pages, with fillable fields, whereas the document or field contents are submitted to a storage system to be retrieved by the offeror for review in regards to the related offer.

This terminology, herein, of “application”, is defined as the process or series of actions taken by the applicants for successful retrieval of an appropriate application form, completion of said form, and submission of said form.

The terminology, herein, of “assimilation” may be defined as the integration of an accepted applicant, or applicants, into an advertised offer, of which is comprised of the forms of job opening, apprenticeship, internship, interview, trial opportunity to fulfill a job opening, organization membership, governmental position, educational institution admittance or studentship, apprenticeship, private group admittance, sports team membership or admittance, private gathering membership, social or commercial event admittance, military service, volunteer service, or personnel opening.

As used herein, the term “computer” means an electronic computing device, including a smartphone, laptop, PC, tablet, etc.

Currently, the method of achieving the result of multiple persons successfully applying together, be it into the same business, organization, social gathering, educational institution, or other institution, group, or alike, is technically general, in that it requires each applicant to apply individually.

In embodiments, the application form is an internet accessible or downloadable document, file a like form of the type comprised of fields that are fillable by a user input system and contained within an electronic document. In embodiments, the application form is a web page, or plurality of web pages comprised of fillable fields, the contents of which can be organized, compiled, and sent to an internet accessible storage device. In some cases, a social network system, comprised of user accounts or profiles, wherein each of the applicants has an account, is used to initiate request to access, access, complete, and submit said application form. In certain cases, an encrypted or simple text key code is used to connect and identify the information of the offer with a corresponding application form via a computer system to validate a key code and transfer correct information from the offer to the corresponding application form.

Disclosed embodiments comprise an advertisement of offer, application form retrieval from a storage system, an application form, submission of application for filing to said storage system, accessing of completed applications from said storage system, and an applicant assimilation format; where a minimum of two applicants is required for this process to work, but additional applicants may be added, as needed, to the process.

The advertisement of offer may be presented as an online advertisement, of which may be comprised of text, graphic, image, video, audio, interactive media, or in any combination of such.

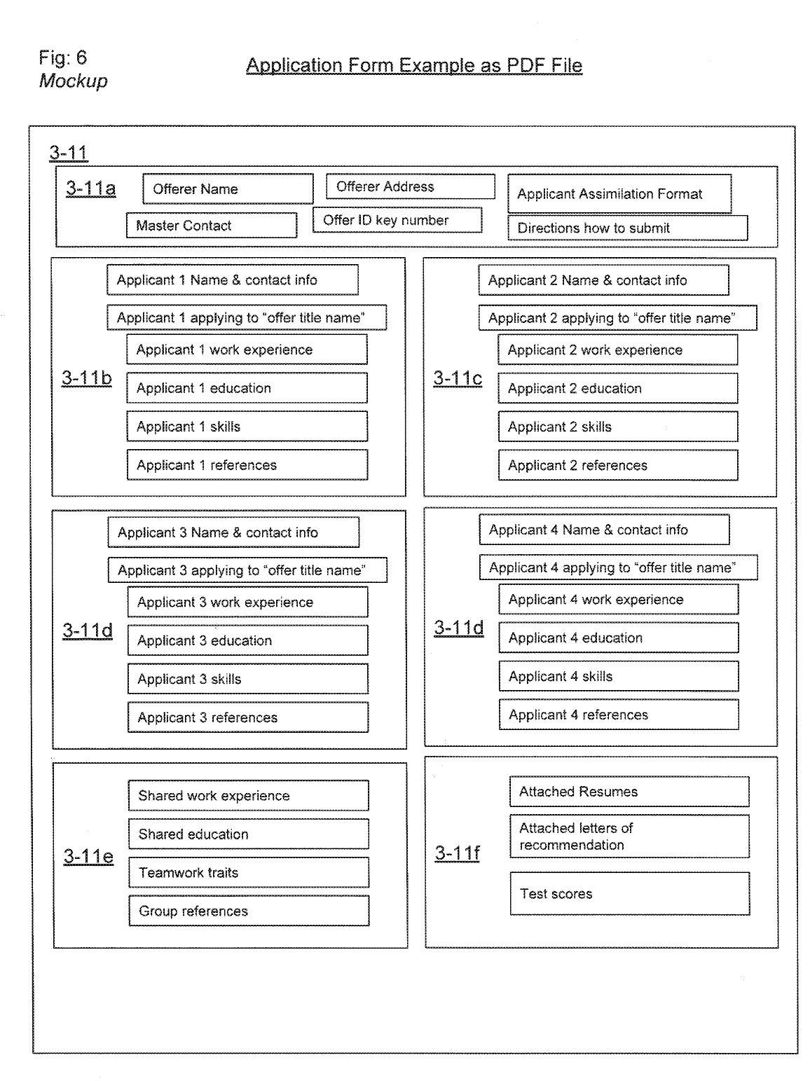

FIG. 6 exemplifies how an advertisement for a job offer, in particular may appear.

In one embodiment of the invention, applicants can retrieve and complete the application form, as well as submit their completed application form without the need for creating individual user accounts or profiles, like in a social network, in order to complete the process. This process may be comprised of the steps: access to a post, listing, query of available offers; request to initiate application form filing process; access to or download of the appropriate application form; completion of said application form; method of submitting completed form for filing; retrieval of submitted application forms by corresponding offeror; and communication between all applicants and offerors involved as to the status of their process. In this embodiment, the application form may take the form of a series of labeled, fillable fields accessible via web page, or series of web pages, or as a downloadable and savable file, such as a .doc, .pdf, .rtf, or the alike.

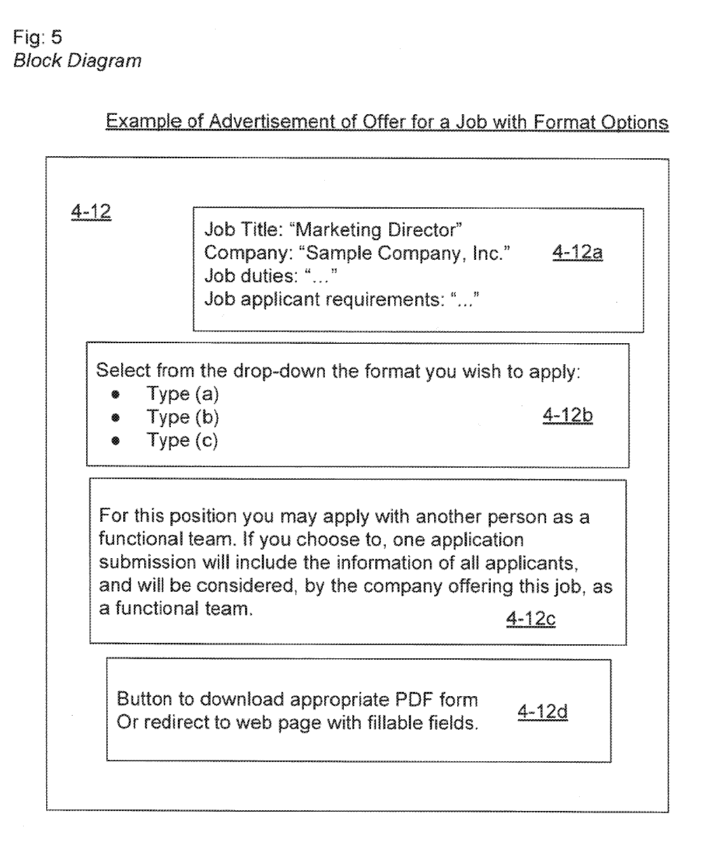

FIG. 5 exemplifies how a saved form may appear as a PDF document.

In another embodiment of the invention, applicants use an online social network with user accounts or profiles to complete this process, of which the steps may be comprised of: the creation of user accounts; connecting between, or “friending” of, separate user accounts; access to a post, listing, or query of available offers; request to initiate application form filing process for a desired offer; connecting with other chosen users of said social network to access the same corresponding application form, completing the data fields of the application form; submitting said application form; retrieval of submitted application forms by corresponding offeror; and communication between all users and offerors involved as to the status of their process.

In one embodiment, a key code may be used to connect and identify an application form to a specific offer, in which will validate the application's intention, destination, and assimilation format. This key code may be comprised of encrypted data or code, or exist as plain text that can be copied into a specified field. This key code may be presented at the point of advertisement of offer, application form retrieval, application form completion, or application form submission.

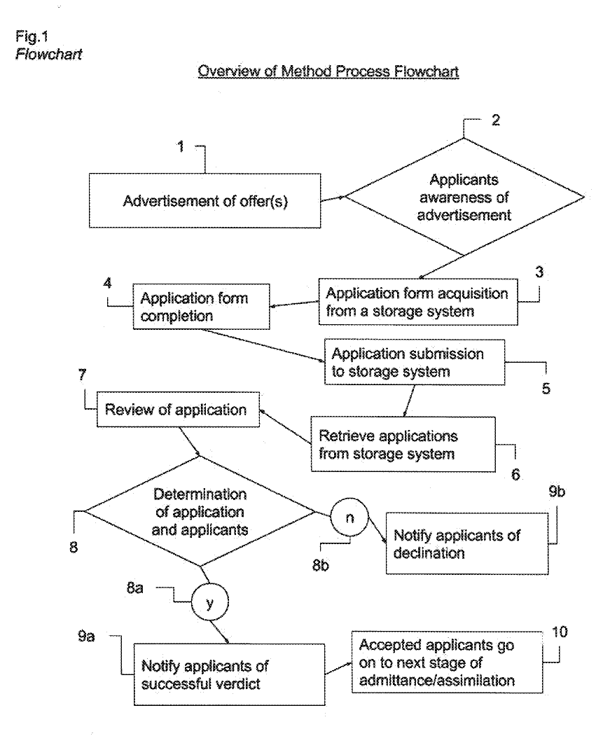

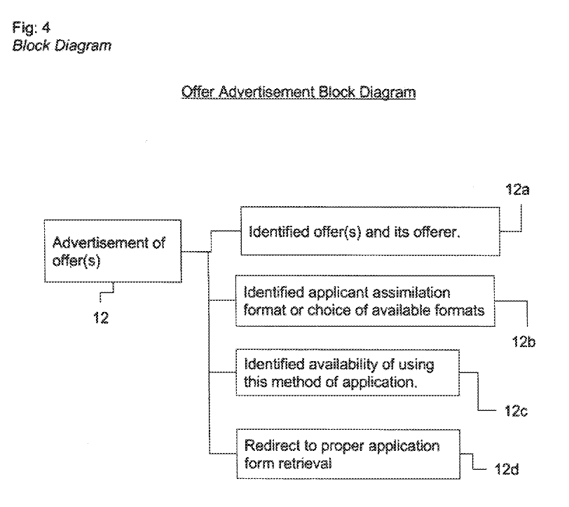

As represented in FIG. 1, the process begins with step 1-1 when an initial advertisement of offer is made available to potential applicants. This advertisement, 4-12, as is shown in detail in FIGS. 4-5, is comprised of information identifying the offer(s) and its offeror or third party representative (4-12a), applicant assimilation format (4-12b), a clear disclosure of accepting this method of application for said offer(s) (4-12c), and a redirecting link to access and complete the application form for selected offer (4-12d).

Applicant assimilation format may take on of the following formats:

Applicants apply into and for a singular or identical specified offer(s), in which all applicants, upon acceptance and assimilation into the stated offer(s), would functionally be placed under an identical title(s), program(s), situation(s), or responsibility(s) at simultaneous operating times and at an identical or different operating location(s);

Applicants apply into and for a singular or identical specified offer(s), in which all applicants, upon acceptance and assimilation into the stated offer(s), would functionally be placed under an identical title(s), program(s), situation(s), or responsibility(s) at different operating times and at an identical or different operating location(s);

Applicants apply into and for different specified offers, in which all applicants, upon acceptance and assimilation into the stated offers, would functionally be placed under different titles, programs, situations, or responsibilities, be it at a simultaneous or different operating time(s) and/or location(s);

Or some combination of the preceding options, whereas a subgroup(s) of the applicants select one of the preceding options that differs from the option choice of another subgroup(s) of applicants.

In example, if the offer was for a job offer:

A single open job position is presented in which multiple people will be hired to work simultaneously on the job work, under identical job titles, either in the same location or remotely via a long distance communication method (ie. telephone, video-call, instant messaging);

A single open job position is presented in which multiple people will hired to work in staggered timeslots (ie. not simultaneously working on the job work) under identical job titles;

Multiple open job positions are presented in which multiple people will be hired, where each hired applicant will be assigned to their own unique position and/or job title;

or some combination of (a), (b), and (c).

In another example, if the offer was for admittance into an educational institution:

Applicants apply into identical degree programs offered by the same educational institution, for which a conscious and fair effort is made by the educational institution to make accepted applicants' learning schedules, class selections, living arrangement, and campus of operation identical via an educational advisor(s) provided by said educational institution;

Applicants apply into differing degree programs offered by the same educational institution, for which a conscious and fair effort is made by the educational institution to make accepted applicants' learning schedules, class selections, living arrangement, campus of operation identical via an educational advisor(s) provided by said educational institution;

Applicants apply into differing degree programs offered by the same educational institution, for which no particular effort is made to unify accepted applicants' learning schedules, class selections, living arrangement, and/or campus of operation;

Or some combination of options (a), (b), and (c).

In one embodiment the applicant assimilation format is a fixed format, specified by the offeror, taking one of the available formats, and stated in the advertisement of offer, or stated within the application form.

In another embodiment the applicant assimilation format is presented as an option for the applicants to choose. This may take the form of a selection redirecting links, each of which corresponds to a specific available format, or via drop-down selection menu and a button to submit format selection, where the applicants are redirected to access the correct application form.

In step 1-2, the applicants are made aware of the offer(s) via said advertisement of offer, and, if option is available, they select their appropriate or desired application assimilation format and submit their choice (4-12b).

In step 1-3, the applicants are redirected to access, download, acquire, gain permission to complete, or otherwise fill in the proper application form with their information (4-12c).

The application form, FIG. 4, is modifiable and adaptable to each unique offering, but has several components that must be present for successful function of the process method. The application form sections presented, herein, including all embodiments, are ordered in a linear fashion that is considered to be the most logical, but in practice can be rearranged, but not eliminated (unless specified as an optional section or process step), as needed for the practical implementation of the invention.

In step 1-4, the applicants complete the application form as appropriate to their unique situation and format.

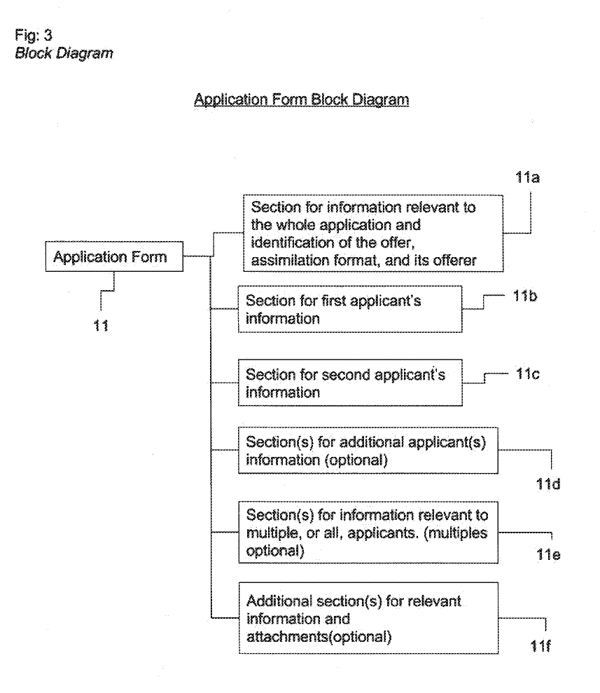

Referring to FIGS. 3 and 6, Section 3-11a of the application pertains to the general information about the application, which is comprised of information relevant to the whole application and identification of the offer(s), applicant assimilation format, and the offeror or third party representative. The content of this section may also include, but is not limited to, the offeror name, contact information, mailing address, and any specifications of preferred application form completion and filing technique. The applicant assimilation format may be set by the offeror, where it is specified in the advertisement and restated in the resulting application form, or be presented as a list of options in the advertisement, or application form, from which the applicants choose and specify their format.

Section 3-11b of the application is comprised of information specifically regarding the first applicant. This information may be comprised of any traits, professional experiences, educational history, skills, references, or other information that makes the applicant desirable or accurately identifies that person for the intention of the application. This section is similar to a traditional application for an individual.

Section 3-11c of the application form is completed with information specifically regarding the second applicant, and is completed in a similar fashion as section 3-11b.

This section may be followed by one or more additional, similar, 3-11d sections intended for any additional applicants, whereas each additional applicant has their own specific 3-11d section for representation of their personal information. Any such sections are then completed in a similar fashion to sections 3-11b and 3-11c.

The 3-11e section(s) is highly practical and useful to the application's purpose, as it is comprised of the skills, traits, experiences, accomplishment, references, and other information that is shared among multiple, or even all, applicants. This section may be replicated to represent various subgroupings of the applicants to contain the information related to that specific subgroup of the applicants. The use of a reference section for the group of applicants is new to the art, as it is traditional for individuals to have references, where it is new and novel to have references in regards to the group of applicants as a whole.

In a particular embodiment, 3-11f sections may be utilized for the filing of other information relevant to the application's purpose as requested by the application offeror. These sections, may be comprised of special requests, such as the attachment of separate documents, files, folders, portfolios, medical records, legal documents, certifications, resumes, or alike materials that aid the applicant selection process that must be added as an attachment and stored within the application form submission.

For example, in an embodiment of the invention where the application form is a .pdf file, FIG. 6, with blank fields to be filled it can be seen how the simplicity of this embodiment may be desirable, as it minimizes the number of systems needed to make the process function.

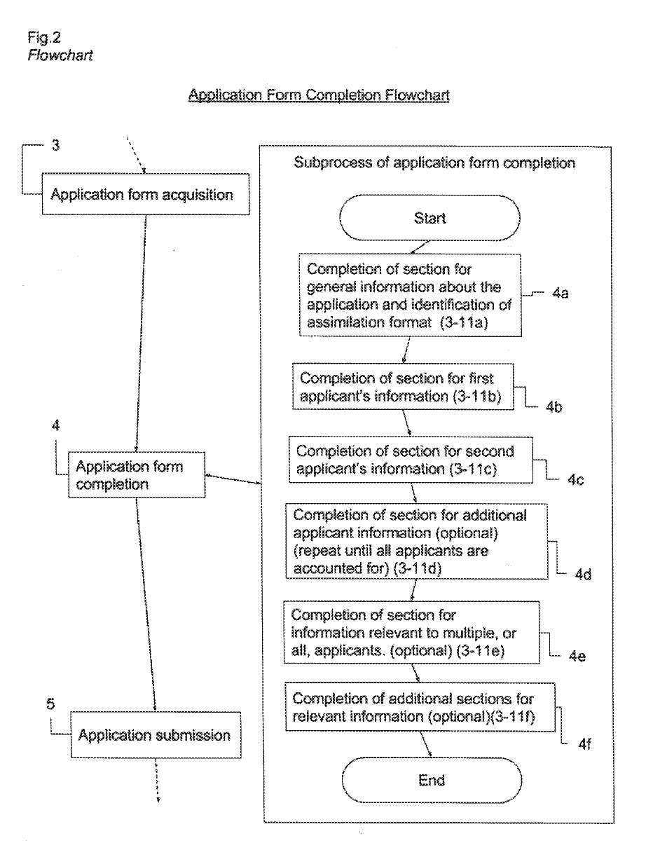

Completing the application form is a subprocess, FIG. 2, comprised of: step 2-4a, comprised of the filling of section 3-11a with information in regards to the application, as a whole; step 2-4b, comprised of the filling of a section 3-11b containing with information relevant to the first applicant only; and step 2-4c, comprised of the filling of section 3-11c with information relevant to the second applicant only.

In one embodiment, the application form completion subprocess may include step 2-4d, of which is comprised of the filing of a 3-11d type section, or a plurality of such sections, with information relevant to any additional applicants, whereas each of the plurality of additional applicants has their own discrete 3-11d type section to complete with their relevant information.

In one embodiment, the application form completion subprocess may include step 2-4e, of which is comprised of the filing of a 3-11e type section, or a plurality of such sections, with information relevant to the group of, or a particular subgroup of, applicants.

In another embodiment, the application form completion subprocess may include step 2-4f, of which is comprised of the filing of 3-11f type sections with additionally requested information, or the attachment of offeror specified document, files, or alike attachable items.

In step 1-5, an application form is submitted for filing to the offeror. This is accomplished via means of electronic submission, comprised of electronic mailing of the application form or its contents, a submission button(s), of which send a request to send application form and its data to a be stored on an electronic storage system, such as a computer with memory, that can be accessed by the offeror in order to review the application and its contents. The submission button may take the form of a locked type, where each applicant must sign or submit an individual key before a request to submit, as sent by said button, will be accepted by the receiving system. Alternatively, a plurality of buttons could be used, whereas each of the applicants has a unique button that must be pressed before the request to submit will be approved by the receiving system.

In step 1-6, an application form recipient accesses the application via application reception system. This system can take the form of e-mail system, online file storage, or similar data collection and storage system, or electronically via internet accessible database. The recipient may be, but is not limited to, an employee or third party representative of the offeror, such as a human resource professional, a hiring committee, admissions council, management personnel, or alike individual in charge of accessing incoming applications.

In step 1-7, the submitted and filed application is reviewed for its contents to determine if it meets the necessary requirements relevant to the offer(s). This may be done by a human or via electronic analysis system, or by some combination of such. The electronic analysis system may support two levels of requirement verification: the first level controlled by the program, which ensures all required fields are populated, and that they are populated with the correct input (ie. only numeric characters input for phone number field, specific format of characters and symbols input for email field); the second level controlled by the offerors, which provides a way to filter the submitted applications on specific field inputs (ie. “only show applications with GPA of 3.5 or higher” or “keyword search”).

In step 1-8, a determination about the application and its applicants is made as to which direction to continue the process. It would be advantageous for an offeror, in example: an employer, to review any 3-11e thoroughly, taking into account their traits, skills, experiences, and references of the group and/or subgroups. It is difficult to build deep and meaningful connections and understanding among employees, but with the inclusion of this section it would become easier for employers to identify high functioning teams before they are integrated or assimilated into the company. Hiring proven and exemplified team could be very beneficial to any business.

If the verdict is positive, 1-8a, meaning that the application and its applicants meet the desired requirements and are of interest, then the process continues to step 1-9a, where the applicants are notified as such and invited to continue the process of assimilation.

If the verdict is negative, 1-8b, meaning that the application and its applicants do not meet the desired requirements and are not of interest, then the process continues to step 1-9b, where the applicants are notified as such and the process is terminated.

In step 1-10, the offeror takes into account the applicant assimilation format and, depending on the intention of the application, address the applicants in the appropriate way. In practice, step 1-10 may be, but is not limited to, an interview(s), placement in job position(s), start or service, entrance to program(s), start of education, or access to information involving one or more of the applicants.

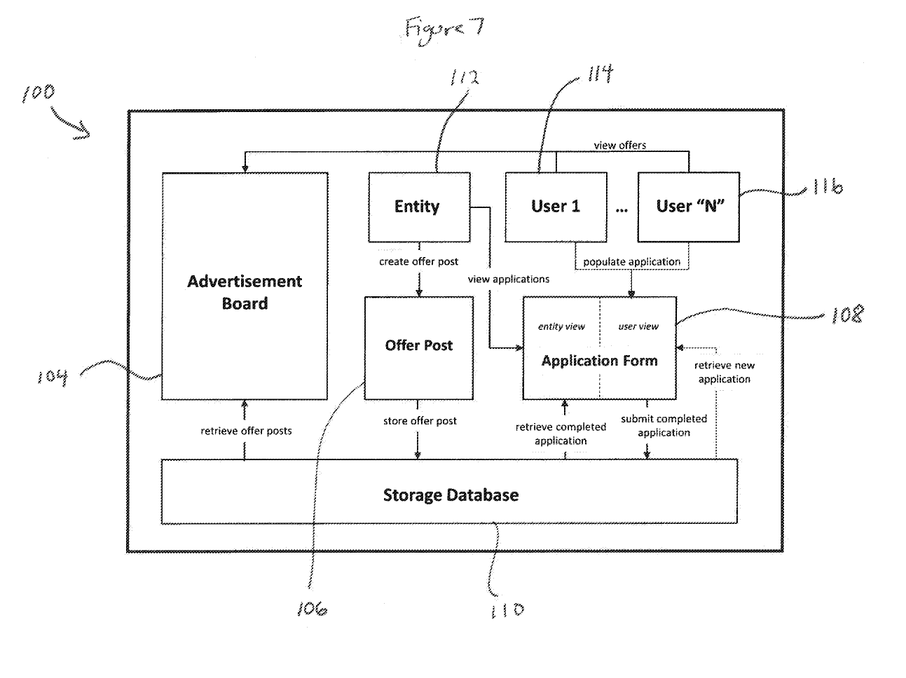

FIG. 7 shows a system according to a first embodiment described herein. The system 100 includes a website 102 that include an advertisement board 104, an offer post page 106, and an application form 108. The system also include a storage database 110 that stores data associated with website 102, including data for the web pages and data received from the employer institute computer user 1 computer 114, and user N computer 116. Optionally, users are validated using an encryption system. Data from entity 112 flows to post page 106 and is stored in storage database 110. Data from the storage database 110 flows to the advertisement board 104. Data from user 1 computer 114 and user 2 computer 116 flows into the application form page 108. The data from the two user computers 114 and 116 is assimilated and stored together in storage database 110.

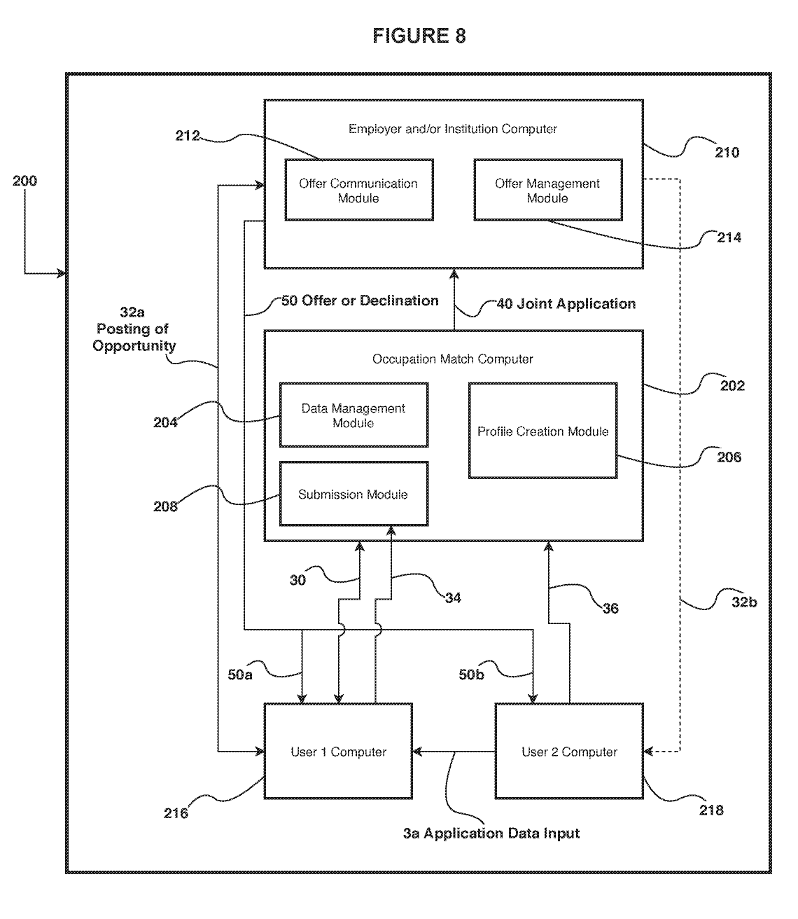

FIG. 8 shows the interrelationship among the modules and computer included in one embodiment described herein. The overall system is designated as 200. In this embodiment there is interaction among 4 computers. The occupation match computer 202 includes a data management module 204, a profile creation module 206, and a submission module 208. The employer/institution computer 210 includes an offer communication module 212 and an offer management module 214. Initially, data flows between user 1 computer 216 and occupation match computer 202 at 30. Optionally data flows from employer/institute computer 210 to user 1 computer 216 and user 2 computer at 32a and 32b, the data being representative of a potential occupation opportunity. User 1 submits application data to occupation match computer 202 at 34. user 2 submits application data to occupation match computer 202 at 36. Occupation match computer 202 submits a single joint application to computer 210 at 40. Computer 210 subsequently transmits data to user 1 computer 216 and/or user 2 computer 218 at 50, the data being representative of a position of dual employment, a position of dual enrollment as students, or a declination. In some cases, application data is transmitted from user 2 computer 218 to user 1 computer 216 before it is submitted to the occupation match computer 202.

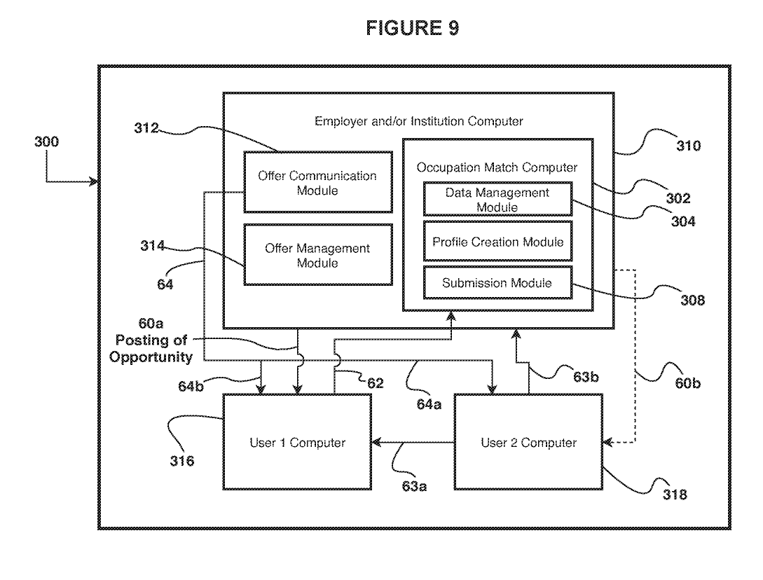

FIG. 9 shows the interrelationship among the modules and computers included in another embodiment described herein. In this embodiment, the overall system is designated as 300. The occupation match computer 302 is incorporated into the employer/institution computer 310. The employer/institution computer 310 also includes an offer communication module 312 and an offer management module 314. In this embodiments data indicative of an opportunity flows at 60a and optionally also at 60b from the employer/institution computer 310 to the user 1 computer 316. The user 1 computer 316 transmits application data to the occupation match computer at 62. This data may include data from user 2 computer 318 transmitted at 63a, or the data for user 2 may go directly to the occupation match computer at 63b. The offer communication module 312 transmits a joint offer the user 1 computer 316 and the user 2 computer 318 at 64. In some cases, this data is transmitted through the occupation match computer 302.

In FIGS. 8-9, in some cases there is a separate communication module on the occupation match computer. In other cases, the communication module is part of the data management module.

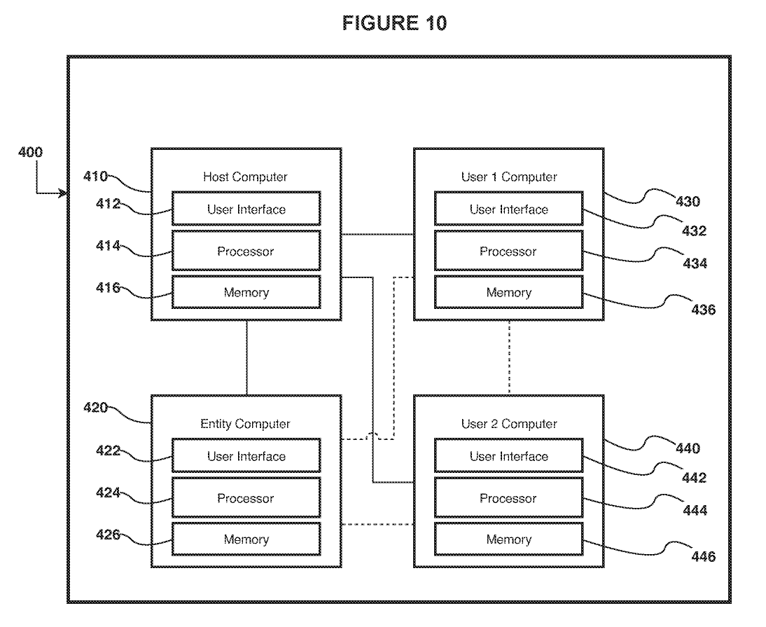

FIG. 10 shows the hardware used in practicing certain embodiments. The overall system is designated as 400. The host computer 410 has a user interface 412, a processor 414 and a memory 416. The entity computer 420 has a user interface 422, a processor 424 and a memory 426. User 1 computer 430 has a user interface 432, a processor 434 and a memory 436. User 2 computer 440 includes a user interface 442, a processor 444 and a memory 446.

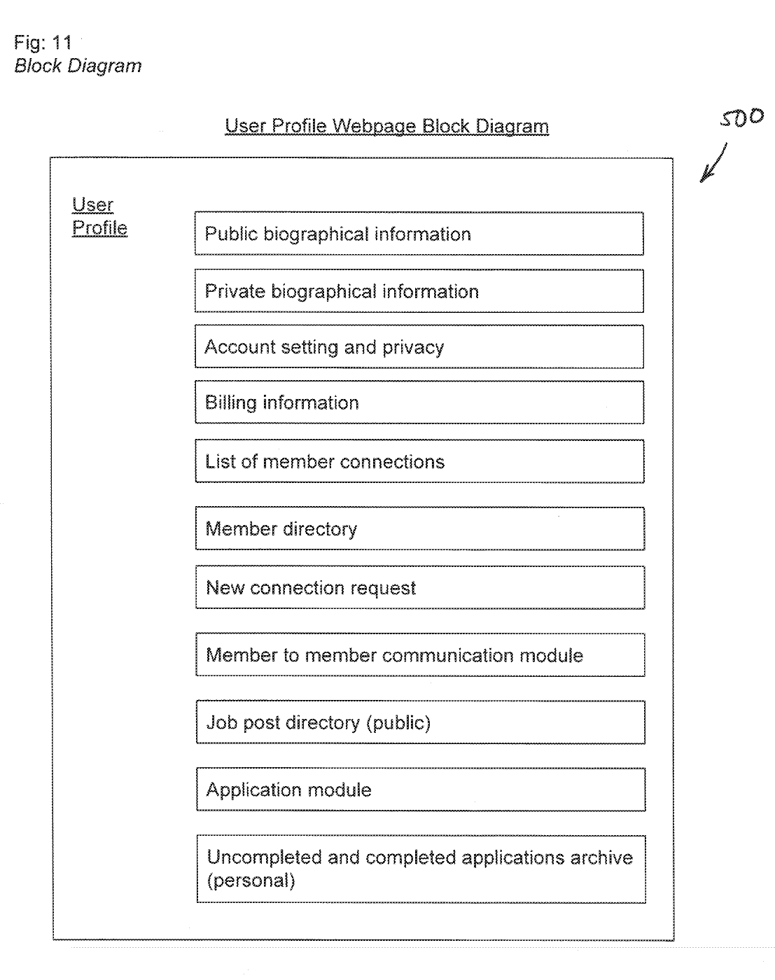

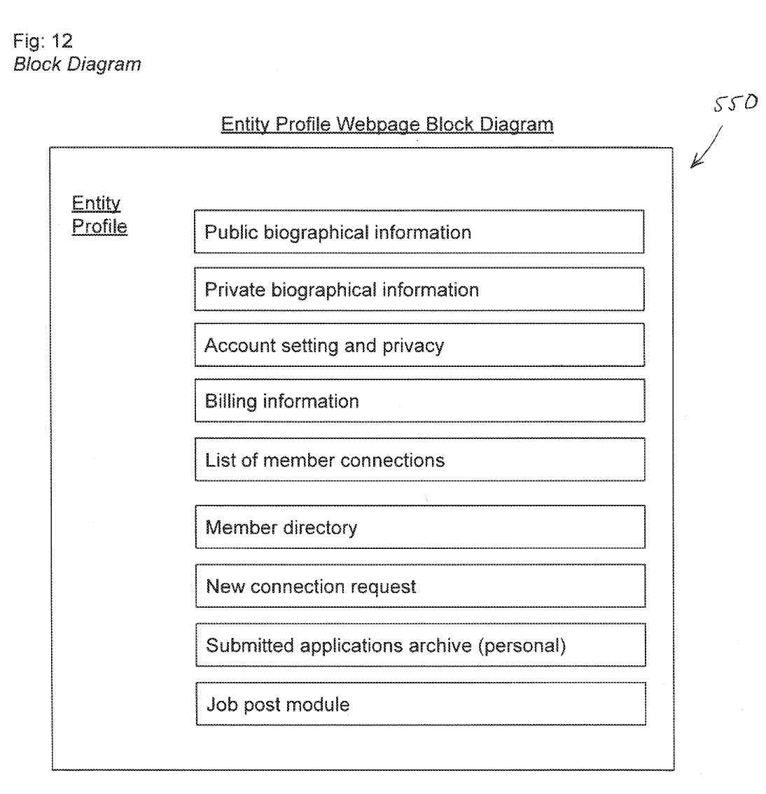

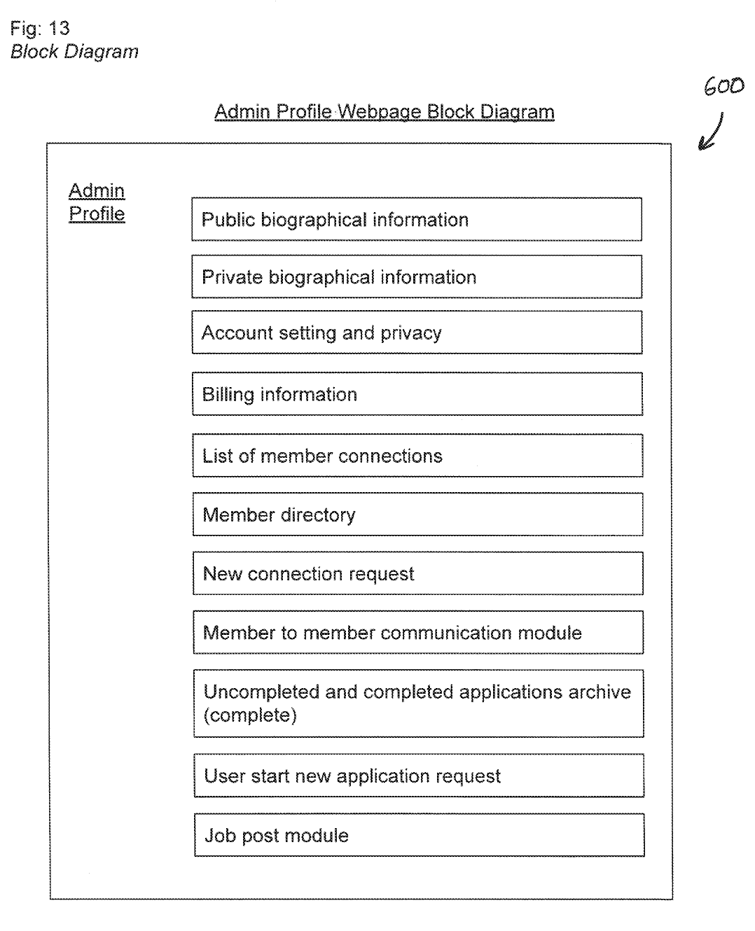

FIG. 11 is a used profile webpage block diagram in accordance with embodiments disclosed herein. The user profile, designated as 500, contains data relating to a particular applicant. FIG. 12 is an entity profile webpage block diagram in accordance with embodiments disclosed herein. The entity profile, designated as 550, contains data for the employer or institution. FIG. 13 is an administrator profile webpage block diagram in accordance with certain embodiments. The administrator profile, designated as 600, contains data for the administrator.

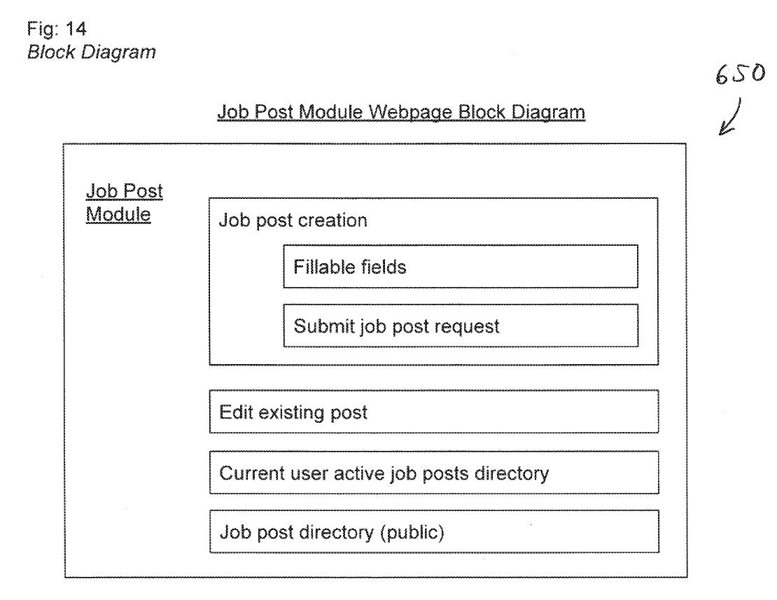

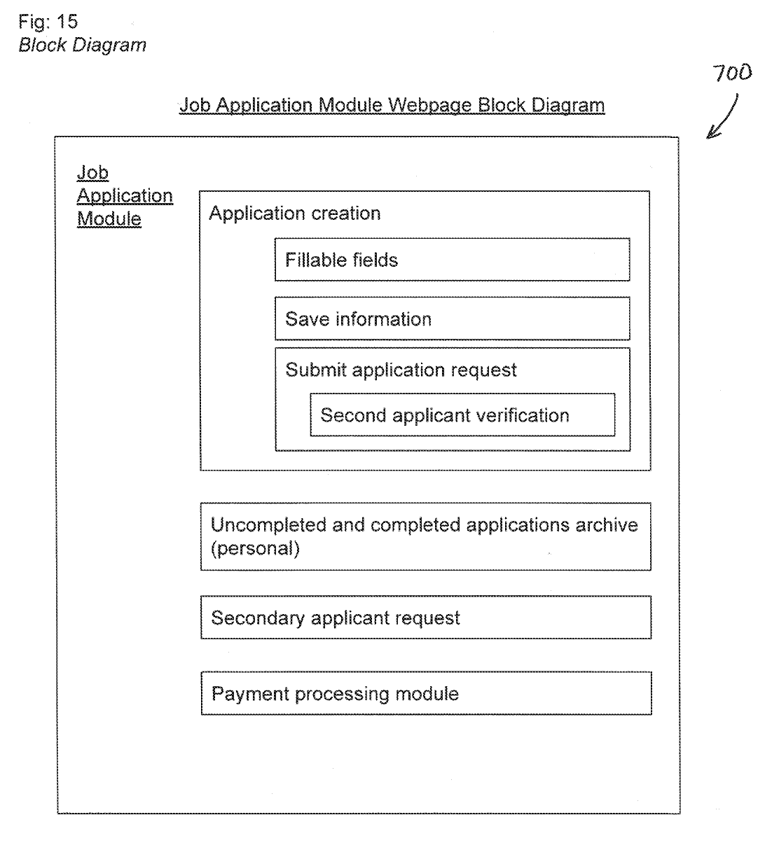

FIG. 14 is a job post module webpage block diagram in accordance with embodiments disclosed herein. The job post module is designated as 650 and contains data for about a job post. FIG. 15 is a job application module webpage block diagram in accordance with embodiments disclosed herein. The job application module is designated as 700 and contains data for a job application.

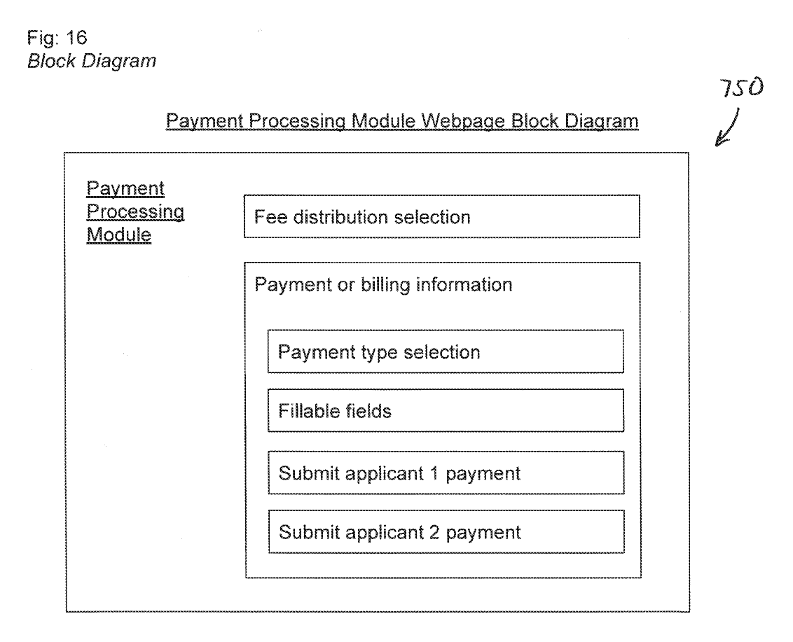

FIG. 16 is a payment processing module block diagram in accordance with embodiments disclosed herein. The payment processing module is designated as 750 and contains data relating to payment by the users and/or the employer or institution.

### Example 1—Applications for Employment

A system was designed to enable multiple job seekers to jointly apply for employment with a single entity. The system is described below:

Log-In System

The log-in process will comprise validation of user credentials, typically comparing the input USER ID and PASSWORD with those stored in the USER PROFILE accounts.
In one embodiment, the USER ID and PASSWORD are successfully validated by the system, causing the JOB SEEKER or EMPLOYER to be redirected to third account portal.
In one embodiment, the USER ID and PASSWORD are not successfully validated by the system, requiring the JOB SEEKER or EMPLOYER to re-enter their credentials for a subsequent attempt to log-in.

USER PROFILE Accounts

JOB SEEKER account
After completing the log-in process, the JOB SEEKER is redirected to their account portal. In one embodiment, the account portal is comprised of a profile page, a settings page, a connections page, and an applications page.
In one embodiment, the profile page allows the JOB SEEKER to complete tasks such as:
   1. Adding and editing contact information (i.e. their name, email, and social media profiles)
   2. Editing credentials (i.e. their user ID and password)
In one embodiment, the settings page allows the JOB SEEKER to complete tasks such as:
   1. Adding payment methods for application fee purposes (i.e. credit cards, debit cards, bank accounts)
   2. Account deletion
In one embodiment, the connections page is comprised of a list of the JOB SEEKER's connections as well as links to each connection's profile page.
In one embodiment, the applications page is comprised of a list of the JOB SEEKER's completed and in-progress applications as well as links to each application page.

### EMPLOYER Account

After completing the log-in process, the EMPLOYER is redirected to their account portal. In one embodiment, the account portal is comprised of a profile page, a settings page, and a job offers page.
In one embodiment, the profile page allows the EMPLOYER to complete tasks such as:
1. Adding and editing contact information (i.e. their name, email, and social media profiles)
2. Editing credentials (i.e. their user ID and password)
   In one embodiment, the settings page allows the EMPLOYER to complete tasks such as:
1. Adding payment methods for application fee purposes (i.e. credit cards, debit cards, bank accounts)
2. Account deletion
   In one embodiment, the job offers page is comprised of a list of the EMPLOYER's active and archived job offers, as well as links to each job offer's detailed information and any applications submitted to the offer.

JOB OFFER Design

A job offer is a subset of job details created by the EMPLOYER. In one embodiment the job offer comprises of: relevant EMPLOYER information; job description and information; and an empty application form for the JOB SEEKER to populate. In one embodiment, the job offer also comprises additional required attachments (ie. letters of recommendation, writing samples).

Create JOB OFFER Process
Upon selection of a “create new job offer” option, or equivalent option, from the job offers page, the EMPLOYER is provided an empty job offer form comprising a plurality of fillable fields.
In one embodiment, a number of the fields can be auto-populated with the EMPLOYER's account information (ie. company name, contact details).
In one embodiment, all required fields in the job offer form must be completed prior to submission to the storage database.
In one embodiment, once the new job offer has been submitted, it is added to the EMPLOYER's job offers page.
In one embodiment, the EMPLOYER must pay a fee before the job offer is visible to JOB SEEKERS (ie. posted to the advertisement board).

Edit JOB OFFER Process

Upon selection of a “edit job offer” option, or equivalent option, from the EMPLOYER's job offers page, the EMPLOYER is provided the existing job offer form.
In one embodiment, the EMPLOYER can edit any number of fields, and then re-submit to the storage database.
In one embodiment, once the updated job offer has been re-submitted, all usages of this job offer will be refreshed to contain the updated information.

Active JOB OFFER Listing System

A job offer listing system searches for active job offers in the storage database, retrieves said offers, and presents said offers to JOB SEEKERS on an advertisement board. In one embodiment, each offer presented comprises of a summarized view of the job offer. In one embodiment, each offer includes a link to the full job offer description created by the EMPLOYER.

APPLICATION Process
Upon selection of an “apply to job offer” option, or equivalent option, the JOB SEEKER is provided an empty application form comprising a plurality of Tillable fields.
In one embodiment, the JOB SEEKER must select at least 1 additional JOB SEEKER to submit the job application with, prior to the application form becoming editable.
In one embodiment, the additional JOB SEEKER(s) added to an application form must agree, via verification process, that the job application can be submitted together.
In one embodiment, the verification process to add additional JOB SEEKERs to an application form consists of the JOB SEEKER clicking a link on a received email to confirm agreement.
In one embodiment, a number of the fields can be auto-populated with the JOB SEEKER's account information (ie. name, contact details).
In one embodiment, all required fields in the application form must be completed by all JOB SEEKERS applying to the job offer in the single form, prior to submission to the storage database.
In one embodiment, once the completed application form has been submitted, it is added to the JOB SEEKER's applications page.
In one embodiment, the JOB SEEKERS must pay a fee before the completed application is visible to the EMPLOYER (ie. shown on EMPLOYER's job offers page, notification sent to EMPLOYER).

### Example 2—Application for Admission to an Academic Institution

A system was designed to enable two or more individuals to jointly apply for admission to an academic institution, sports team, etc. using a joint application. The system is described below:

Log-In System

The log-in process will comprise validation of user credentials, typically comparing the input USER ID and PASSWORD with those stored in the USER PROFILE accounts. In one embodiment, the USER ID and PASSWORD are successfully validated by the system, causing the APPLICANT or INSTITUTION to be redirected to their account portal.
In one embodiment, the USER ID and PASSWORD are not successfully validated by the system, requiring the APPLICANT or INSTITUTION to re-enter their credentials for a subsequent attempt to log-in.

USER PROFILE Account

### APPLICANT FOR ADMISSION Account

After completing the log-in process, the APPLICANT is redirected to their account portal. In one embodiment, the account portal is comprised of a profile page, a settings page, a connections page, and an applications page.
In one embodiment, the profile page allows the APPLICANT to complete tasks such as:
1. Adding and editing contact information (i.e. their name, email, and social media profiles)
2. Editing credentials (i.e. their user ID and password)
   In one embodiment, the settings page allows the APPLICANT to complete tasks such as:
1. Adding payment methods for application fee purposes (i.e. credit cards, debit cards, bank accounts)
2. Account deletion
   In one embodiment, the connections page is comprised of a list of the APPLICANT's connections as well as links to each connection's profile page.
   In one embodiment, the applications page is comprised of a list of the APPLICANT's completed and in-progress applications as well as links to each application page.

INSTITUTION Account

After completing the log-in process, the INSTITUTION is redirected to their account portal. In one embodiment, the account portal is comprised of a profile page, a settings page, and position offers page.
In one embodiment, the profile page allows the INSTITUTION to complete tasks such as:
1. Adding and editing contact information (i.e. their name, email, and social media profiles)
2. Editing credentials (i.e. their user ID and password)
   In one embodiment, the settings page allows the INSTITUTION to complete tasks such as:
1. Adding payment methods for application fee purposes (i.e. credit cards, debit cards, bank accounts)
2. Account deletion
   In one embodiment, the position offers page is comprised of a list of the INSTITUTION's active and archived position offers, as well as links to each position offer's detailed information and any applications submitted to the offer.

POSITION OFFER Design

A position offer is a subset of position details created by the INSTITUTION. In one embodiment the position offer comprises of: relevant INSTITUTION information; position description and information; and an empty application form for the APPLICANTS to populate. In one embodiment, the position offer also comprises additional required attachments (ie. letters of recommendation, writing samples).

Create POSITION OFFER Process
Upon selection of a “create new position offer” option, or equivalent option, from the position offers page, the INSTITUTION is provided an empty position offer form comprising a plurality of fillable fields.
In one embodiment, a number of the fields can be auto-populated with the INSTITUTION's account information (ie. institution name, contact details).
In one embodiment, all required fields in the position offer form must be completed prior to submission to the storage database.
In one embodiment, once the new position offer has been submitted, it is added to the INSTITUTION's position offers page.
In one embodiment, the INSTITUTION must pay a fee before the position offer is visible to APPLICANTS (ie. posted to the advertisement board).

Edit POSITION OFFER Process

Upon selection of a “edit position offer” option, or equivalent option, from the INSTITUTION's position offers page, the INSTITUTION is provided the existing position offer form.
In one embodiment, the INSTITUTION can edit any number of fields, and then re-submit to the storage database.
In one embodiment, once the updated position offer has been re-submitted, all usages of this position offer will be refreshed to contain the updated information.

Active POSITION OFFER Listing System

A position offer listing system searches for active position offers in the storage database, retrieves said offers, and presents said offers to APPLICANTS on an advertisement board. In one embodiment, each offer presented comprises of a summarized view of the position offer. In one embodiment, each offer includes a link to the full position offer description created by the INSTITUTION.

APPLICATION Process
Upon selection of an “apply to position offer” option, or equivalent option, the APPLICANT is provided an empty application form comprising a plurality of fillable fields.
In one embodiment, the APPLICANT must select at least 1 additional APPLICANT to submit the position application with, prior to the application form becoming editable.
In one embodiment, the additional APPLICANT(s) added to an application form must agree, via verification process, that the position application can be submitted together.
In one embodiment, the verification process to add additional APPLICANTs to an application form consists of the APPLICANTs clicking a link on a received email to confirm agreement.
In one embodiment, a number of the fields can be auto-populated with the APPLICANT's account information (ie. name, contact details).
In one embodiment, all required fields in the application form must be completed by all APPLICANTs applying to the position offer in the single form, prior to submission to the storage database.
In one embodiment, once the completed application form has been submitted, it is added to the APPLICANT's applications page.
In one embodiment, the APPLICANTs must pay a fee before the completed application is visible to the INSTITUTION (ie. shown on INSTITUTION's position offers page, notification sent to INSTITUTION).

### Advantages

The benefit of having an online resume generator, allowing the user to enter their information, via a user interface, is inherent, in that it allows for an orderly presentation of, but is not limited to, the traits, skills, experiences, or other beneficial information about the parties involved, as related to the application in question, or intended receiver. This technique is, generally, to the effect of increasing the aesthetic quality of a resume via computer aided graphic rendering of the applicant's information, as well as offer an improvement in the process of candidate selection, thus an improvement to the company, school, or specific resume receiver by higher accuracy of candidate selection. Additionally, there is a benefit to the technique, herein, as it increases the efficiency of candidate application to a desired occupation. This is greatly apparent in the improvements to the completion and submission steps by eliminating a need for individual applicants to submit information individually, and allows for an automated system to validate and analyze the credentials of multiple applicants at one time, thus reducing the time it takes to fill an equal number of open positions.

What is claimed is:

1. A method for application of and assimilation of a plurality of persons to an offer, the method comprising:
providing, via a webpage, an advertisement board comprising a plurality of offers, the advertisement board being in communication with a storage database and capable of displaying two or more offers, the offers posted by an enterprise, organization, institution or alike institute;
retrieving, via the computer, the application form for a posted offer from a storage database, the offer corresponding to a practice, employment, studentship or alike opening;
providing, via a webpage, the application form for a selected posted offer, wherein the application form is populated by a plurality of persons; and
submitting, via the computer, the completed application form for a posted offer to a storage database;
wherein a plurality of persons applying to the posted offer are represented in a single form.

2. The method of claim 1, further comprising:
validating, via the computer, the plurality of persons completing the application form for a posted offer, prior to allowing submission of the completed form.

3. The method of claim 1, further comprising:
retrieving, via the computer, the completed application form for a posted offer from a storage database; and
providing, via a webpage, a view of the retrieved completed application form;
wherein the completed application form is assessed on the plurality of persons represented in the single form.

4. The method of claim 3, further comprising:
transmitting, via a computer, a proposal of terms for assimilation of the plurality of persons into the enterprise, organization or institution.

5. The method of claim 1, wherein each of the plurality of persons submits a separate portion of the completed application form from a different computer, and the method further comprises processing the portions of the application form in a computerized processor to generate and store the single form.

6. The method of claim 1, wherein the application for the posted offer is a form comprising:
a section for general information about the application, the posted offer, the offeror, and identification of assimilation format;
“N” sections for the applicants' individual information, where “N” is the number of applicants applying;
a section for information relevant to a plurality of the applicants.

7. The method of claim 6, wherein the application form comprises an internet accessible or downloadable document, file or alike form with fillable fields for each section.

8. The method of claim 6, wherein the application form comprises a web page, or plurality of web pages, with fillable fields for each section.

9. The method of claim 1, wherein the posted offer comprises text, graphics, images, videos, audio recordings, interactive media, or any combination of such.

10. The method of claim 1, further comprising:
creating user accounts after receiving key codes, wherein each individual receives a separate key code.

11. The method of claim 1, further comprising:
identifying, via encrypted or simple text key code, the application form for a posted offer from a storage database;
wherein the key code is used to validate the application form retrieved from the storage database with the posted offer provided on the advertisement board.

12. The method of claim 4, wherein the assimilation of the plurality of persons comprises:
selecting said persons for a singular or identical specified offer;
wherein the persons are placed under an identical title, program, situation, or responsibility;
wherein the operating times and operating locations of the plurality of persons may differ.

13. The method of claim 4, wherein the assimilation of the plurality of persons comprises:
selecting said persons for different or unique specified offers;
wherein the persons are placed under different titles, programs, situations, or responsibilities;
wherein the operating times and operating locations of the plurality of persons may differ.

14. The method of claim 1, wherein the offer is an offer of occupation.

15. An apparatus comprising:
an advertisement board module in communication with a storage database that provides, via a webpage, an advertisement board comprising a plurality of offers, the advertisement board module capable of displaying two or more offers;
an application module in communication with a storage database that:
retrieves, via the computer, the application form for a posted offer from the storage database, the offer corresponding to a practice, employment, studentship or alike opening;
provides, via a webpage, the application form for a selected posted offer;
wherein the application form is populated by a plurality of persons; and
submits, via the computer, the completed application form for a posted offer to the storage database;
retrieves, via the computer, the completed application form for a posted offer from a storage database;
provides, via a webpage, a view of the retrieved completed application form; and
transmits, via a computer, a proposal of terms for assimilation of the plurality of persons into the enterprise, organization, institution or alike institute; and
a user profile module that:
manages one or more users having accounts;
wherein the user accounts can be created, modified or removed; and
connects user profiles during application of and assimilation of a plurality of user profiles to an offer.

16. A computer program product comprising a non-transitory computer readable storage medium storing computer readable program code, the program code, when executed by a processor, cause the processor to perform:
providing, via a webpage, an advertisement board comprising a plurality of offers, the advertisement board being in communication with a storage database and capable of displaying two or more offers, the offers posted by an enterprise, organization, institution or alike institute;
retrieving, via the computer, the application form for a posted offer from a storage database, the offer corresponding to a practice, employment, studentship or alike opening;
providing, via a webpage, the application form for a selected posted offer;
wherein the application form is populated by a plurality of persons; and
submitting, via the computer, the completed application form for a posted offer to a storage database;
wherein a plurality of persons applying to the posted offer are represented in a single form.

17. The computer program product of claim 16, the program code further causing the processor to perform:
validating, via the computer, the plurality of persons completing the application form for a posted offer, prior to allowing submission of the completed form.
retrieving, via the computer, the completed application form for a posted offer from a storage database; and
providing, via a webpage, a view of the retrieved completed application form;
wherein the completed application form is assessed on the plurality of persons represented in the single form.
transmitting, via a computer, a proposal of terms for assimilation of the plurality of persons into the enterprise, organization, institution or alike institute.
